(19) United States
(12) Patent Application Publication
(10) Pub. No.: US 2021/0298291 A1
(43) Pub. Date: Sep. 30, 2021

(54) AUXILIARY DEVICE FOR CRYOPRESERVATION

(71) Applicant: MITSUBISHI PAPER MILLS LIMITED, Tokyo (JP)

(72) Inventor: Atsushi Matsuzawa, Tokyo (JP)

(73) Assignee: MITSUBISHI PAPER MILLS LIMITED, Tokyo (JP)

(21) Appl. No.: 17/212,298

(22) Filed: Mar. 25, 2021

(30) Foreign Application Priority Data
Mar. 25, 2020 (JP) 2020-053497

(51) Int. Cl. A01N 1/02

(52) U.S. Cl. CPC A01N 1/0268

(57) ABSTRACT

The present invention relates to an auxiliary device for cryopreservation that is capable of stably holding a device for cryopreservation, facilitates coverage of a cell or tissue deposited on a strip with a cap without allowing the cap to come into contact with the cell or tissue, and enables quick immersion of the device for cryopreservation in liquid nitrogen. The present invention relates specifically to an auxiliary device for cryopreservation, including: a substrate; a cap holder; an observation section having an aperture structure; and a device body holder, the cap holder, the observation section having an aperture structure, and the device body holder being arranged in the substrate in a substantially straight line.

### CROSS-REFERENCE TO RELATED APPLICATIONS

The present application claims priority under 35 U.S.C. § 119 to Japanese Patent Application No. 2020-053497 filed on Mar. 25, 2020, the contents of which are incorporated herein by reference in their entirety.

### BACKGROUND OF THE INVENTION

### Field of the Invention

The present invention relates to an auxiliary device for cryopreservation suitably used for cryopreservation of a cell or tissue.

### Description of Related Art

Excellent preservation techniques for cells or tissues are desired in various industrial fields. For example, in the bovine embryo transfer technology, embryos are cryopreserved in advance and thawed and transferred in time with the estrus cycle of a recipient cow. In the human fertility treatment, eggs or ovaries are harvested from a woman's body and cryopreserved until an appropriate timing for transplantation, and the cryopreserved eggs or ovaries are thawed before the use in transplantation.

In general, cells or tissues harvested from living bodies gradually become inactive even in a culture medium, and hence long-term culture of cells or tissues in vitro is undesirable. For this reason, techniques for long-term preservation of cells or tissues without the loss of biological activity are essential. Excellent preservation techniques enable more accurate analysis of cells or tissues harvested. Such excellent preservation techniques also enable transplantation of cells or tissues with their biological activity kept at a higher level, thus likely resulting in an improvement in the engraftment rate. The techniques also enable in-advance production and preservation of artificial tissues for transplantation, such as skins cultured in vitro and what they call cell sheets formed in vitro, and storage thereof until needed. Therefore, such excellent preservation techniques are expected to bring great advantages not only in the medical science fields but also in the industrial fields.

One of known methods for cryopreserving cells or tissues is slow freezing, for example. In this method, cells or tissues are immersed in a preservation solution prepared by adding a cryoprotectant to a physiological solution such as phosphate buffered saline. Examples of the cryoprotectant include compounds such as glycerol, ethylene glycol, and dimethyl sulfoxide. The cells or tissues immersed in the preservation solution are cooled down to −30° C. to −35° C. at a relatively slow cooling rate (for example, 0.3° C. to 0.5° C./min), and thereby the solution inside and outside the cells or tissues are sufficiently cooled and become viscous. Further cooling down the cells or tissues in such a state in the preservation solution to the temperature of liquid nitrogen (−196° C.) allows a slight amount of the solution both inside and outside (surrounding) the cells or tissues to become a solid while the amorphous state thereof is maintained, that is, to vitrify. The vitrification (i.e., solidification) of the solution inside and outside the cells or tissues substantially immobilizes the molecules. Thus, the vitrified cells or tissues can be semipermanently preserved in liquid nitrogen.

Another known method for cryopreserving cells or tissues is the vitrification method. The vitrification method is a technique using a principle that addition of a large amount of a cryoprotectant, such as glycerol, ethylene glycol, or dimethyl sulfoxide, to a preservation solution decreases the freezing point of the preservation solution, thereby restraining formation of ice crystals at sub-zero temperatures. When quickly cooled in liquid nitrogen, the preservation solution can solidify without formation of ice crystals. This solidification is called vitrification. The preservation solution containing a large amount of a cryoprotectant is called a vitrification solution.

However, since the slow freezing requires relatively slow-rate cooling, the procedure of cryopreservation takes a long time. Further, this technique disadvantageously requires a device or jig for controlling the cooling rate. In addition, the slow freezing cannot avoid formation of ice crystals in the preservation solution outside the cells or tissues, which may cause physical damage to the cells or tissues. In contrast, the vitrification method is a process which advantageously requires a short period of time for the procedure of cryopreservation without the use of any special device or jig. In addition, since forming no ice crystals, the vitrification method can achieve a high viability.

Various examples of the vitrification-based cryopreservation of cells or tissues have been reported using various methods and various cells or tissues. For example, JP 3044323 B discloses that application of the vitrification method to reproductive or somatic cells of animal or human origin is very useful in terms of the cell viability after cryopreservation and thawing.

The vitrification method is a technique which has been developed mainly using human reproductive cells. More recently, its application to iPS or ES cells has also been widely examined. Steponkus et al., Nature 345: 170-172 (1990) discloses the effectiveness of the vitrification method in preservation of Drosophila embryos. JP 2008-5846 A discloses the effectiveness of the vitrification method in preservation of plant culture cells and tissues. As mentioned here, the vitrification method is known to be useful for preservation of a wide range and different kinds of cells and tissues.

A faster freezing speed is known to be preferred for appropriate vitrification. A faster thawing speed is also known to be preferred in thawing after cryopreservation because faster thawing inhibits re-formation of ice crystals in the cells or tissues.

A typical vitrification-based cryopreservation method is disclosed in JP 2000-189155 A. JP 2000-189155 A suggests a method of attaching mammalian embryos or eggs to the inner surface of a cryopreservation container, such as a freezing straw, freezing vial, or freezing tube, with the minimum amount of a vitrification solution required to cover these embryos or eggs, and quenching the container by bringing the container into contact with liquid nitrogen. The method for thawing after the freezing includes taking out the cryopreservation container stored by the method described above from the liquid nitrogen, opening one end of the container, and injecting a 33° C. to 39° C. dilute solution into the container to thaw and dilute the frozen embryos or eggs. This method is described to allow storage and thawing dilution of mammalian embryos or eggs with a high viability without the risk of contamination of the embryos or eggs with viruses or bacteria. However, there may be difficulty in attaching embryos or eggs to the inner surface of a cryopreservation container such as a freezing straw, freezing vial, or freezing tube, and also in confirming deposition of the embryos or eggs in the cryopreservation container. In addition, the process may be complicated as it uses special tools, including a straw sealer for freezing and a straw cutter for thawing.

JP 5798633 B teaches a cell cryopreservation tool including a cell holding member with a heat conductor and a tubular accommodation member. This tool solves the problems in the freezing and thawing methods in JP 2000-189155 A to some extent. The cryopreservation tool described in JP 5798633 B is specifically used as follows. First, eggs are attached to the cell holding member under a microscope. The cell holding member is inserted into the tubular accommodation member, which is then immersed in liquid nitrogen to vitrify the eggs. A lid member is mounted on the open portion of the tubular accommodation member. Thereafter, the accommodation member is put in a liquid nitrogen tank to store the eggs.

JP 2014-183757 A, JP 2015-142523 A and WO 2015/064380 each suggest a device for cryopreservation which enables cryopreservation of cells or tissues with a high viability through deposition of the cells or tissues together with a preservation solution containing a large amount of a cryoprotectant on a preservation solution removing material and the subsequent removal of excess preservation solution surrounding the cells or tissues. JP 2014-183757 A discloses a preservation solution absorber having a certain haze value. JP 2015-142523 A and WO 2015/064380 each disclose a device for cryopreservation by vitrification including, as a preservation solution absorber, a porous sintered article or a porous structure made of a material having a certain refractive index.

JP 2014-183757 A, JP 2015-142523 A and WO 2015/064380 each disclose a cryopreservation method which includes freezing cells or tissues without contact between the cells or tissues and liquid nitrogen. The method is described to maintain an aseptic condition by dropping and attaching the cells or tissues to the preservation solution removing material and then covering a strip containing the preservation solution removing material with a cap. WO 2019/004300 describes a cryopreservation method including inserting the whole device for cryopreservation, including the living cell holding part on which a small amount of vitrification solution and eggs are deposited, into a tubular accommodation container, and immersing the container in liquid nitrogen to vitrify the eggs.

Meanwhile, JP 6636202 B discloses a tool used in a process prior to freezing of cells to improve the working efficiency in the freezing in a cryopreservation method. The tool is provided with a groove in which a plate-shaped cell freezing part for freezing fertilized eggs is to be placed. The groove can be formed into a shape corresponding to the handle shape of the cell freezing part. In this case, the tip of the cell freezing part fixed projects from the tool, so that cells can be dropped and attached under observation with a transmission microscope.

### CITATION LIST

### Patent Literature

Patent Literature 1: JP 3044323 B
Patent Literature 2: JP 2008-5846 A
Patent Literature 3: JP 2000-189155 A
Patent Literature 4: JP 5798633 B
Patent Literature 5: JP 2014-183757 A
Patent Literature 6: JP 2015-142523 A
Patent Literature 7: WO 2015/064380
Patent Literature 8: WO 2019/004300
Patent Literature 9: JP 6636202 B

### Non-Patent Literature

Non-Patent Literature 1: Steponkus et al., Nature 345: 170-172 (1990)

### BRIEF SUMMARY OF THE INVENTION

The tool described in JP 6636202 B may be used to cover with a cap a preservation solution removing material or a strip of the cell holding part on which cells or tissues are deposited in freezing using a tool, device, or the like for cryopreservation described in any of JP 5798633 B, JP 2014-183757 A, JP 2015-142523 A and WO 2015/064380. In this case, there may be difficulty in quickly covering with a cap the cells or tissues deposited on the preservation solution removing material or the strip without contact between the cap and the cells or tissues. In addition, such a covering operation may inhibit quick freezing of cells or tissues in the vitrification method, which is achieved by quickly immersing a preservation solution removing material or a strip with the cells or tissues deposited thereon in liquid nitrogen. Such quick freezing is considered important in the vitrification method from the viewpoint of toxicity of the cryoprotectant contained in the vitrification solution at a high concentration.

The present invention mainly aims to provide an auxiliary device for cryopreservation used to achieve a favorable working efficiency in freezing in cryopreservation of a cell or tissue by the vitrification method. The present invention specifically aims to provide an auxiliary device for cryopreservation that, in cryopreservation of a cell or tissue, can stably hold a device for cryopreservation, facilitates coverage of the cells or tissues deposited on a strip with a cap without allowing the cap to come into contact with the cell or tissue, and enables quick immersion of the device for cryopreservation in liquid nitrogen.

The present inventors made intensive studies to solve the problem, and found that the problem can be solved by an auxiliary device for cryopreservation having the following structure.

The present invention relates to an auxiliary device for cryopreservation, including: a substrate; a cap holder; an observation section having an aperture structure; and a device body holder, the cap holder, the observation section having an aperture structure, and the device body holder being arranged on the substrate in a substantially straight line.

The present invention can provide an auxiliary device for cryopreservation that, in cryopreservation of a cell or tissue, can stably hold a device for cryopreservation, facilitates coverage of the cell or tissue deposited on a strip with a cap without allowing the cap to come into contact with the cell or tissue, and enables quick immersion of the device for cryopreservation in liquid nitrogen.

### BRIEF DESCRIPTION OF THE DRAWINGS

FIG. 1 is a schematic top view showing an embodiment of the auxiliary device for cryopreservation of the present invention.

FIG. 2 is a schematic cross-sectional view of a cap holder of the auxiliary device for cryopreservation in FIG. 1.

FIG. 3 is a schematic cross-sectional view of a device body holder of the auxiliary device for cryopreservation in FIG. 1.

FIG. 4 is a schematic cross-sectional view of an observation section having an aperture structure of the auxiliary device for cryopreservation in FIG. 1.

FIG. 5 is a schematic cross-sectional view taken in the major axis direction of the auxiliary device for cryopreservation in FIG. 1.

FIG. 6 is a schematic top view showing another embodiment of the auxiliary device for cryopreservation of the present invention.

FIG. 7 is a schematic cross-sectional view of a cap holder of the auxiliary device for cryopreservation in FIG. 6.

FIG. 8 is a schematic top view showing yet another embodiment of the auxiliary device for cryopreservation of the present invention.

FIG. 9 is a schematic top view showing yet another embodiment of the auxiliary device for cryopreservation of the present invention.

FIG. 10 is a schematic top view showing yet another embodiment of the auxiliary device for cryopreservation of the present invention.

FIG. 11 is a schematic top view showing yet another embodiment of the auxiliary device for cryopreservation of the present invention.

FIG. 12 is a schematic view showing one embodiment of the state where the auxiliary device for cryopreservation of the present invention holds a cap and a device body of a device for cryopreservation.

FIG. 13 is a schematic cross-sectional view taken along the dashed line Q in FIG. 12, seen in the direction from the device body holder 3 to the cap holder 2.

FIG. 14 is a schematic cross-sectional view taken along the dashed line S in FIG. 12, seen in the direction from the cap holder 2 to the device body holder 3.

FIG. 15 is a schematic cross-sectional view taken along the dashed line R in FIG. 12, seen in the direction from the device body holder 3 to the cap holder 2.

FIG. 16 is a schematic cross-sectional view taken along the dashed line T in FIG. 12.

FIG. 17 is a schematic view showing one embodiment of the state where a cell or tissue is dropped and attached to a strip of a device for cryopreservation using the auxiliary device for cryopreservation of the present invention.

FIG. 18 is a schematic view showing one embodiment of the state where a device body and a cap are fitted and fixed using the auxiliary device for cryopreservation of the present invention.

FIG. 19 is a schematic view showing another embodiment of the state where a device body and a cap are fitted and fixed using the auxiliary device for cryopreservation of the present invention.

### DETAILED DESCRIPTION OF THE INVENTION

The auxiliary device for cryopreservation of the present invention is used to hold a device for cryopreservation for use in cryopreservation of a cell or tissue. The auxiliary device for cryopreservation of the present invention is suitably used in freezing a cell or tissue by what is called the vitrification method. In the present invention, the “cell” encompasses not only a single cell but also a biological cell population composed of multiple cells. The “cell population composed of multiple cells” may be a colony or cluster composed of a single kind of cells or may be a colony or cluster composed of multiple kinds of cells. The “tissue” may be composed of a single kind of cells or may be composed of multiple kinds of cells, or may contain a non-cellular substance like an extracellular matrix in addition to cells. The auxiliary device for cryopreservation of the present invention is particularly suitable for cryopreservation of an egg or embryo.

The auxiliary device for cryopreservation of the present invention is described in detail below.

The auxiliary device for cryopreservation of the present invention (hereinafter, also referred to as “the auxiliary device of the present invention”) is capable of detachably holding a cap and a device body of a device for cryopreservation. In other words, the auxiliary device of the present invention can hold the device for cryopreservation with or without the cap and the device body fitted to each other. Use of the auxiliary device of the present invention achieves quick, easy fitting of the cap and the device body without allowing the cap to come into contact with the cell or tissue deposited on a strip provided to the device body.

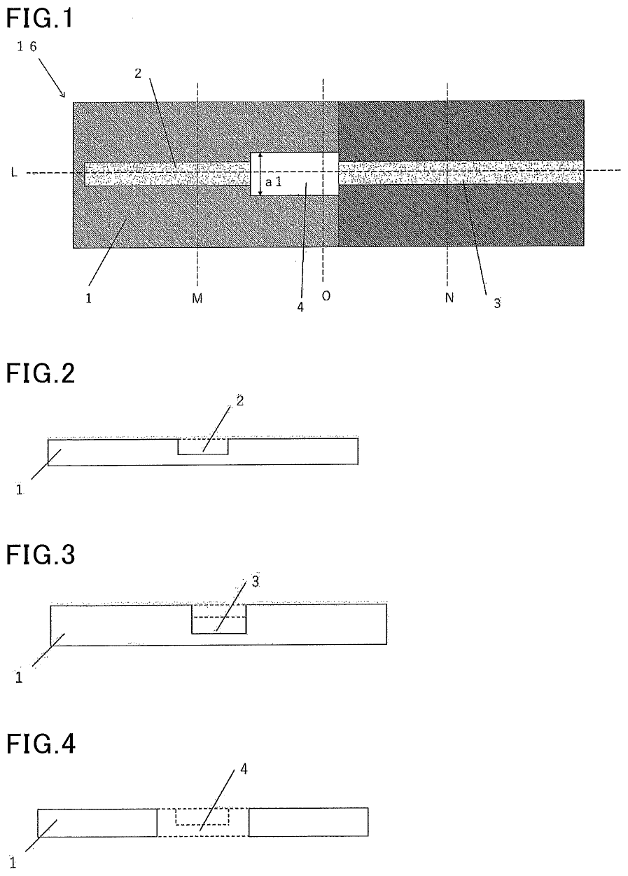

The auxiliary device of the present invention includes a cap holder, an observation section having an aperture structure (hereinafter, also simply referred to as an “observation section”), and a device body holder being arranged on a substrate in a substantially straight line. As described below, the cap holder and the device body holder need to hold and slide the cap and the device body of the device for cryopreservation, respectively. Thus, the region of the cap holder and the region of the device body holder in a top view, which is the viewing direction in FIG. 1, each have a groove-like (elongated) outline shape with two parallel sides extending in the major axis direction of the substrate. The region of the cap holder having an elongated shape and the region of the device body holder having an elongated shape in the auxiliary device of the present invention are adjacent in the major axis direction with the region of the observation section having an aperture structure in between. The arrangement in a substantially straight line in the present invention means that one straight line (e.g., the later-described dashed line L in FIG. 1) is assumed to penetrate the region of the cap holder, the region of the observation section having an aperture structure, and the region of the device body holder in the major axis direction.

Use of the auxiliary device of the present invention enables stable holding of the device for cryopreservation in which a cell or tissue is not yet disposed (the device for cryopreservation with the strip exposed without being covered with the cap). The auxiliary device also enables dropping and attachment of a cell or tissue to the strip provided in the device body of the device for cryopreservation under microscopic observation with favorable visibility, owing to its observation section having an aperture structure.

Furthermore, use of the auxiliary device of the present invention, after dropping and attachment of a cell or tissue to the strip provided in the device body, facilitates coverage of the strip with the cap without allowing the cap to come into contact with the cell or tissue deposited on the strip by sliding the cap held by the cap holder in the direction of the device body holder or by sliding the device body held by the device body holder in the direction of the cap holder. The use also enables quick, easy fitting and fixing of the cap and the device body. The use of the auxiliary device of the present invention therefore enables quick, easy freezing of the cell or tissue.

The auxiliary device of the present invention is further described with reference to the drawings.

FIG. 1 is a schematic top view showing one embodiment of the auxiliary device for cryopreservation of the present invention. In an auxiliary device for cryopreservation 16, a cap holder 2, an observation section having an aperture structure 4, and a device body holder 3 are arranged on a substrate 1 in a substantially straight line.

FIG. 2 is a schematic cross-sectional view of the cap holder of the auxiliary device for cryopreservation in FIG. 1. Specifically, FIG. 2 is a schematic cross-sectional view taken along the dashed line M in FIG. 1, seen in the direction from the device body holder 3 to the cap holder 2. The cap holder 2 formed on the substrate 1 in FIG. 2 is provided with a groove (depression) to hold the cap of the device for cryopreservation (not shown). In the schematic cross-sectional views described below, including FIG. 2, the outline of a cross section of the auxiliary device for cryopreservation is drawn with a solid line, while the outline of the auxiliary device for cryopreservation not present but projected on the cross section is drawn with a dotted line.

Examples of the shape of the groove (cross-sectional shape) described above include semi-circles, semi-ellipses, and polygons each with an upper opening. From the viewpoint of secure holding of the cap and the working efficiency in sliding the cap, the groove preferably has a bottom face and wall faces, particularly preferably a rectangular or square shape.

When the cap holder 2 of the auxiliary device 16 of the present invention is provided with a groove having a bottom face and wall faces, the width of the bottom face of the groove is preferably 100 to 150% of the width of the cap of the device for cryopreservation to be held. In consideration of the size of commonly used devices for cryopreservation, the width of the bottom face of the groove is preferably 2.3 to 4.8 mm. The height of the wall faces (the depth of the groove) is appropriately adjustable according to the size of the cap. The height of the wall faces of the cap holder 2 is preferably 10 to 120%, more preferably 20 to 80%, of the height of the cap. In consideration of the size of commonly used devices for cryopreservation, the height of the wall faces (the depth of the groove) is preferably 0.2 to 3.8 mm, more preferably 0.4 to 2.6 mm. If the height of the wall faces is less than 10% of the height of the cap, it may be difficult for the cap holder 2 to stably hold the cap. If the height of the wall faces is more than 120% of the height of the cap, the working efficiency may decrease when the cap held by the cap holder 2 is moved in the direction of the device body along the wall faces after dropping and attachment of a cell or tissue to the strip.

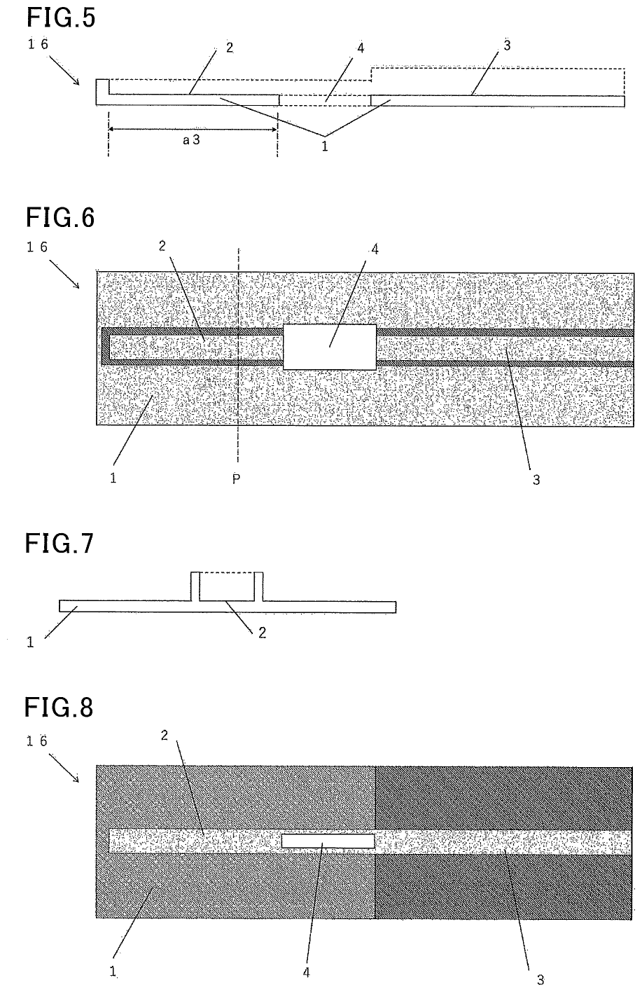

The length of the cap holder 2 (the length in the major axis direction, e.g., a3 in FIG. 5) of the auxiliary device 16 of the present invention is appropriately adjustable according to the length of the cap (e.g., a4 in FIG. 16) of the device for cryopreservation to be held. The length of the cap holder 2 is preferably 50 to 150%, more preferably. 60 to 100%, of the length of the cap. In consideration of the size of commonly used devices for cryopreservation, the length of the cap holder 2 (the length in the major axis direction) is preferably 22.0 to 100 mm, more preferably 26.0 to 66.0 mm. If the length of the cap holder 2 is less than 50% of the length of the cap in the major axis direction, it may be difficult for the cap holder 2 to stably hold the cap. If the length of the cap holder 2 is more than 150% of the length of the cap in the major axis direction, it may be difficult for the cap holder 2 to hold the cap always at the same position, which may decrease the working efficiency.

FIG. 3 is a schematic cross-sectional view of the device body holder of the auxiliary device for cryopreservation in FIG. 1. FIG. 3 is a schematic cross-sectional view taken along the dashed line N in FIG. 1, seen in the direction from the device body holder 3 to the cap holder 2. The device body holder 3 formed on the substrate 1 is provided with a groove to hold the device body (specifically, the handle of the device body, e.g. handle 9 in FIG. 12) of the device for cryopreservation (not shown).

The device body holder 3 in FIG. 3 is provided with a groove capable of stably holding the device body of the device for cryopreservation. The device body holder 3 may have any shape according to the cross-sectional shape of the handle of the device body. As described below, the handle preferably has a rectangular or square cross-sectional shape. In this case, the groove preferably has a bottom face and wall faces. The width of the bottom face of the groove is preferably 100 to 150% of the width of the handle of the device body. In consideration of the size of commonly used devices for cryopreservation, the width of the bottom face of the groove is preferably 2.4 to 4.9 mm. This enables easy fitting of the cap and the device body.

When the device body holder 3 of the auxiliary device 16 of the present invention is provided with a groove having a bottom face and wall faces, the height of the wall faces is appropriately adjustable according to the size of the device body of the device for cryopreservation to be held. The height of the wall faces is preferably 10 to 120%, more preferably 50 to 100%, of the height of the handle of the device body. In consideration of the size of commonly used devices for cryopreservation, the height of the wall faces is preferably 0.2 to 4.0 mm, more preferably 1.1 to 3.3 mm. If the height of the wall faces is less than 10% of the height of the handle, it may be difficult for the device body holder 3 to stably hold the device body. If the height of the wall faces is more than 120% of the height of the handle, the wall faces may interfere with detachment of the device for cryopreservation from the auxiliary device 16 of the present invention, decreasing the working efficiency.

The length of the device body holder 3 in the major axis direction in the present invention is appropriately adjustable according to the length in the major axis direction of the device body of the device for cryopreservation to be held. The length of the device body holder 3 is preferably 30 to 150%, more preferably 40 to 70%, of the length in the major axis direction of the grippable portion of the device body (the total length in the major axis direction of the later-described fitting structure and the handle). In consideration of the size of commonly used devices for cryopreservation, the length of the device body holder 3 in the major axis direction is preferably 26.0 to 160 mm, more preferably 34.0 to 71.0 mm. If the length of the device body holder 3 is less than 30% of the length in the major axis direction of the grippable portion of the device body, it may be difficult for the device body holder 3 to stably hold the device body. If the length of the device body holder 3 is more than 150% of the length in the major axis direction of the grippable portion of the device body, it may be difficult for the device body holder 3 to hold the device body always at the same position, which may decrease the working efficiency.

FIG. 4 is a schematic cross-sectional view of the observation section having an aperture structure of the auxiliary device for cryopreservation in FIG. 1. FIG. 4 is a schematic cross-sectional view taken along the dashed line O in FIG. 1, seen in the direction from the device body holder 3 to the cap holder 2. The observation section having an aperture structure 4 is an aperture that penetrates the substrate 1.

The observation section 4 of the auxiliary device of the present invention has an aperture structure. In observation of a cell or tissue with a transmission microscope having a bottom light source (hereinafter, such observation is also simply referred to as “microscopic observation”) during dropping and attachment of the cell or tissue to the strip in freezing, the aperture structure of the observation section 4 allows observation of the cell or tissue with a favorable visibility without scattering of observation light (parallel light) from the light source. When a transmission microscope having a top light source is used, any other material is not present between the eyepiece and the strip to be observed, so that the cell or tissue can be observed with a favorable visibility.

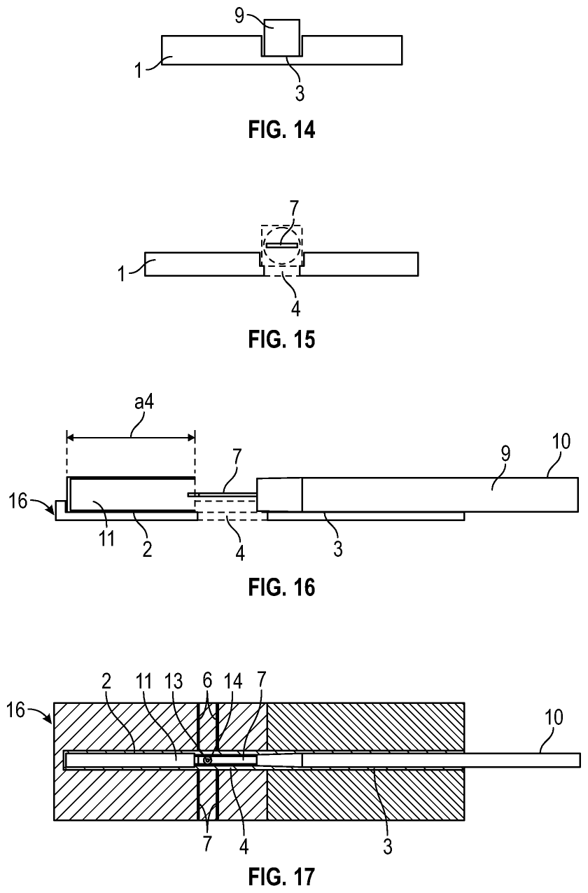

As shown in FIG. 4, the observation section 4 of the auxiliary device for cryopreservation 16 having the structure shown in FIG. 1 has the wall faces alone on a cross section, and the entire region of the observation section 4 defines an aperture. In such a structure, the width of the observation section (a1 in FIG. 1) needs to be equal to or larger than the width of the cap (in FIG. 1, the dimension of the cap in the direction perpendicular to the dashed line L, e.g., a2 in FIG. 13 described later) and the width of the device body (e.g., the width of a handle 9 in FIG. 14 described later). If the width of the observation section is smaller than the width of the cap or the device body, the cap or the device body cannot pass through the observation section when the cap or the device body is slid, which leads to a failure in fitting of the cap to the device body. If the width of the observation section is very large, the moving direction of the cap tends to be offset from the direction of the device body when moved by sliding, which may decrease the working efficiency. The width of the observation section is therefore preferably twice the width of the cap or smaller. In consideration of the size of commonly used devices for cryopreservation, the width of the observation section is preferably 6.4 mm or less. If the length of the observation section in the direction of the dashed line L approaches the length of the cap (e.g., a4 in FIG. 16 described later), the cap may fall through the aperture of the observation section when moved by sliding. Thus, the length of the observation section is preferably 80% or less of the length of the cap, with a sufficient field of view achieved under microscopic observation. In consideration of the size of commonly used devices for cryopreservation, the length of the observation section is preferably 53 mm or less. In order to eliminate such restriction, a structure is preferred in which the wall faces and the bottom faces of the cap holder 2 and the device body holder 3 are continuous and the observation section having an aperture structure is provided in the bottom faces. Such a preferred embodiment of the present invention is described later with reference to the drawings including FIG. 8.

FIG. 5 is a schematic cross-sectional view taken in the major axis direction of the auxiliary device for cryopreservation in FIG. 1. In FIG. 1, the bottom face of the cap holder 2 and the bottom face of the device body holder 3 are at the same height. In this case, at least one of the cap or the device body is preferably moved along the bottom face, so that the cap and the device body can be fitted easily.

In the present invention, the end (the end remote from the device body holder 3) of the cap holder 2 of the auxiliary device for cryopreservation 16 is preferably blocked, not open. The “blocked” state herein means a structure which prevents the cap held by the cap holder from moving beyond the end when the cap is moved by sliding along the wall faces. The cap holder 2 with its end blocked can hold the cap alongside the blocked portion, for example, thereby easily holding the cap always at the same position and easily allowing the observation section having an aperture structure 4 to be always at the same position. Such a configuration of the auxiliary device for cryopreservation 16 is preferred in order to reduce the burden on the worker.

Other embodiments of the auxiliary device of the present invention are described below with reference to the drawings.

FIG. 6 is a schematic top view showing another embodiment of the auxiliary device for cryopreservation of the present invention. The cap holder 2 and the device body holder 3 in the auxiliary device for cryopreservation 16 shown in FIG. 1 to FIG. 5 are defined by the groove (depression) in the substrate 1. The cap holder 2 and the device body holder 3 in the auxiliary device for cryopreservation 16 shown in FIG. 6 are each defined by two parallel walls (projections) on the substrate 1. FIG. 6 also shows an embodiment of the auxiliary device for cryopreservation in which the height of the walls of the cap holder 2 and the height of the walls of the device body holder 3 are the same.

FIG. 7 is a schematic cross-sectional view of a cap holder of the auxiliary device for cryopreservation in FIG. 6, which is taken along the dashed line P in FIG. 6 and seen in the direction from the observation section having an aperture structure 4 to the cap holder 2. The auxiliary device for cryopreservation 16 in FIG. 7 includes the cap holder 2 and the device body holder 3 each defined by two lines of projections on the substrate 1 in order to hold a device for cryopreservation (not shown).

FIG. 8 is a schematic top view showing yet another embodiment of the auxiliary device for cryopreservation of the present invention in FIG. 1. Specifically, the auxiliary device for cryopreservation 16 in FIG. 8 includes the cap holder 2, the observation section having an aperture structure 4, and the device body holder 3 arranged on the substrate 1 in a substantially straight line. The width of the observation section 4 (the length in the direction perpendicular to the direction in which the cap is horizontally moved along the wall faces toward the device body) is smaller than the width of the cap holder 2 and the width of device body holder 3, and also has a structure in which the wall faces and bottom faces of the cap holder 2 and the device body holder 3 are continuous. This structure is, in other words, a structure in which the aperture of the observation section having an aperture structure 4 is surrounded by the bottom faces. The auxiliary device for cryopreservation 16 having such a structure prevents the ends of the cap from entering the aperture of the observation section 4, increasing the working efficiency in sliding the cap or device body of the device for cryopreservation (not shown). The width of the observation section 4 is preferably smaller than the width of the cap (a2 in FIG. 13), and is preferably 50 to 98% of the width of the cap. In consideration of the size of commonly used devices for cryopreservation, the width of the observation section 4 is preferably 3.2 mm or less, more preferably 1.6 to 3.1 mm. If the width of the observation section 4 is less than 50% of the width of the cap, the field of view under microscopic observation may be narrow, leading to poor observability. If the width of the observation section 4 is more than 98% of the width of the cap, the working efficiency may decrease due to a defect such as that an end of the cap enters the aperture of the observation section 4 when the cap is moved by sliding. The length of the observation section 4 is not limited as long as a sufficient field of view is achieved under microscopic observation since the bottom face surrounding the aperture prevents the ends of the cap from entering the aperture of the observation section 4.

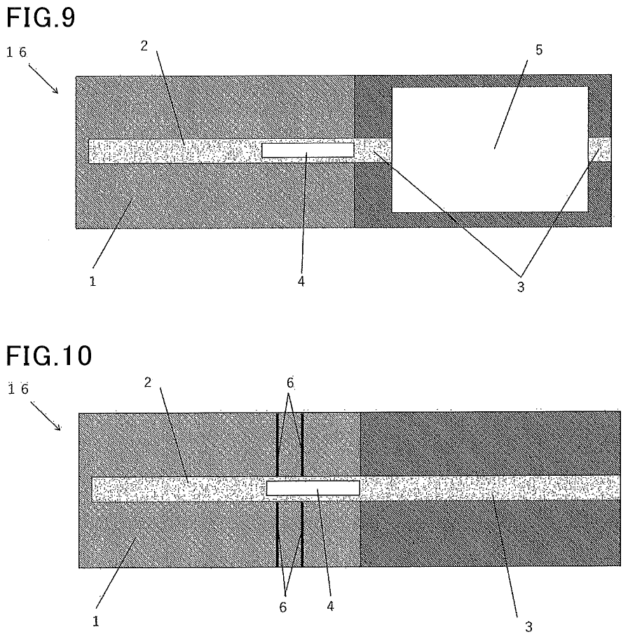

FIG. 9 is a schematic top view showing yet another embodiment of the auxiliary device for cryopreservation of the present invention. The auxiliary device for cryopreservation 16 shown in FIG. 9 has a structure in which the cap holder 2, the observation section having an aperture structure 4, and the device body holder 3 are arranged on the substrate 1 in a substantially straight line. The device body holder 3 is partly provided with a cavity 5. The cavity 5 has an aperture structure penetrating the substrate 1. The device body holder 3 is divided into two parts by the cavity 5. This structure prevents the hand of a worker from interfering with the wall faces of the device body holder 3 when the handle is gripped to detach the device for cryopreservation after dropping and attachment of a cell or tissue to the device for cryopreservation (not shown). Thus, the device for cryopreservation to which the cap is fitted and fixed can be easily detached.

FIG. 10 is a schematic top view showing yet another embodiment of the auxiliary device for cryopreservation of the present invention. The auxiliary device for cryopreservation 16 shown in FIG. 10 includes a reference position indicator 6 adjacent to the observation section having an aperture structure 4 on the substrate 1. The reference position indicator 6 has only to be provided adjacent to either side of the observation section having an aperture structure 4 on the substrate 1, preferably adjacent to each side of the observation section 4 on the substrate 1. The device body is disposed such that the strip of the device body (particularly the portion on the strip where the cell or tissue is deposited) is close to the reference position indicator 6. This allows the worker to easily recognize the position to which a cell or tissue is to be dropped and attached together with a preservation solution, further increasing the workability of freezing.

Examples of the reference position indicator 6 include marked lines and lines formed by an uneven structure.

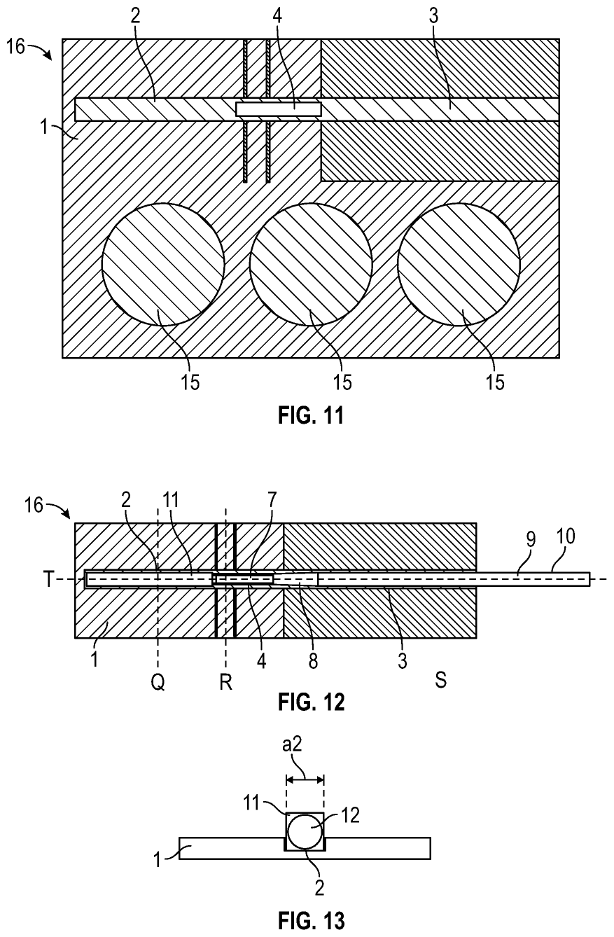

FIG. 11 is a schematic top view showing yet another embodiment of the auxiliary device for cryopreservation of the present invention. The auxiliary device for cryopreservation 16 shown in FIG. 11 includes, on the substrate 1, wells 15 as well as the cap holder 2, the observation section having an aperture structure 4, and the device body holder 3 to hold the device for cryopreservation (not shown). When an equilibrium solution or vitrification solution is stored in the wells 15 of the auxiliary device for cryopreservation, for example, the wells 15 allow smooth dropping and attachment of a cell or tissue to the device for cryopreservation after equilibration of the cell or tissue to be vitrified or immersion of the equilibrated cell or tissue in the vitrification solution. This allows quicker freezing for cryopreservation by vitrification.

Suitable examples of the substrate defining the auxiliary device of the present invention include various metals such as aluminum, iron, copper, and stainless alloys; ABS resin, acrylic resin, polypropylene resin, polystyrene resin, polyethylene resin, polycarbonate resin, fluorine resins, and various engineering plastics; glass materials, and rubber materials. In particular, a light transmissive substrate having a total light transmittance of 80% or higher is preferred because such a substrate allows, for example, identification of the position of a cell or tissue accidentally adhering to the auxiliary device for cryopreservation to collect the cell or tissue, under observation with a transmission microscope. Examples of such a light transmissive substrate include ABS resin, acrylic resin, polypropylene resin, polystyrene resin, polyethylene resin, fluorine resins, and glass.

In the auxiliary device of the present invention, there is preferably no step between the bottom faces of the cap holder, observation section having an aperture structure, and device body holder arranged in a substantially straight line. As described later, for cryopreservation using the auxiliary device of the present invention, the cap and the device are fitted to each other, for example, by sliding the cap toward the device body (or vice versa) after the cell or tissue is deposited on the strip of the device body. The fitting can be performed with favorable working efficiency when there is no step between the bottom faces of the cap holder, observation section having an aperture structure, and device body holder. There is also preferably no step between the wall faces of the cap holder, observation section having an aperture structure, and device body holder.

The bottom faces and the wall faces may be roughened or have a groove structure (depressed structure) parallel to the direction in which the cap or device body is to be slid, in order to adjust the sliding condition of the cap and the device body.

Next, a cryopreservation method using the auxiliary device of the present invention is described in detail.

The auxiliary device of the present invention can be suitably used in freezing of a cell or tissue in the vitrification method. Typically, what is called the vitrification method uses a device for cryopreservation including a rectangular strip for cryopreservation of a cell or tissue. Such devices for cryopreservation are disclosed in, for example, JP 2002-315573 A, JP 2006-271395 A, and WO 2011/070973, as well as the above-mentioned JP 5798633 B, JP 2014-183757 A, JP 2015-142523 A, WO 2015/064380 and WO 2019/004300.

The freezing in the vitrification method using the auxiliary device of the present invention includes, prior to dropping and attachment of a cell or tissue to the strip together with a preservation solution, disposing the cap on the cap holder and the device body on the device body holder, with the cap and device body of the device for cryopreservation separated.

FIG. 12 is a schematic view showing an embodiment of the state where the auxiliary device for cryopreservation of the present invention holds the cap and the device body of the device for cryopreservation. A device body 10 of a device for cryopreservation used in the present embodiment includes a strip 7, and a fitting structure 8 and the handle 9 used to fit the cap. The cap holder 2 of the auxiliary device for cryopreservation 16 holds a cap 11. The device body holder 3 holds the handle 9 of the device body 10 (or may hold part of the fitting structure 8). The strip 7 of the device body 10 is positioned above the observation section having an aperture structure 4, so that the cell or tissue to be deposited on the strip 7 is observable under a microscope (not shown).

An equilibrated cell or tissue is then dropped and attached to the strip 7 provided on the device body of the device for cryopreservation together with the preservation solution. This process is preferably performed under a transmission microscope. Here, the strip 7 of the device for cryopreservation preferably includes a preservation solution absorber because the absorber can effectively remove excess preservation solution. The strip 7 is preferred to include a preservation solution absorber also because the preservation solution around the cell or tissue can be more reduced, and thus a high freezing speed and a high thawing speed can be achieved.

FIG. 13 is a schematic cross-sectional view taken along the dashed line Q in FIG. 12, seen in the direction from the device body holder 3 to the cap holder 2. The cap holder 2 shown in FIG. 13 holds the cap 11 having a quadrilateral prism shape that is provided with a cavity 12 having a cylindrical shape.

FIG. 14 is a schematic cross-sectional view taken along the dashed line S in FIG. 12, seen in the direction from the cap holder 2 to the device body holder 3. The device body holder 3 shown in FIG. 14 holds the handle 9 having a quadrilateral prism shape.

FIG. 15 is a schematic cross-sectional view taken along the dashed line R in FIG. 12, seen in the direction from the device body holder 3 to the cap holder 2. The strip 7 of the device body is positioned above the observation section having an aperture structure 4 shown in FIG. 15. The width of the observation section having an aperture structure 4 is slightly larger than the width of the strip 7, so that the whole strip in the width direction can be clearly observed in observation with a transmission microscope. The strip 7 to which a cell or tissue is to be dropped and attached does not come into contact with the substrate 1. This prevents foreign matter or bacteria from adhering to the strip 7, keeping cleanliness of the strip 7.

FIG. 16 is a schematic cross-sectional view taken along the dashed line T in FIG. 12. As shown in FIG. 16, the auxiliary device for cryopreservation 16 includes the cap holder 2, the observation section having an aperture structure 4, and the device body holder 3. The cap holder 2 holds the cap 11 and the device body holder 3 holds the device body 10. Preferably, the end of the cap holder 2 (the end remote from the observation section 4) is blocked and the surface of the blocked portion has a shape conforming to the shape of the distal end of the cap 11 (the distal end on the side without the opening of the cap 11). This makes it easy to hold the cap always at the same position. The device body 10 is disposed with the strip 7 of the device body 10 positioned above the observation section having an aperture structure 4. Also, as shown in FIG. 16, the distal end of the strip 7 is preferably slightly inserted into the cavity of the cap 11 in advance before deposition of a cell or tissue because the working efficiency in fitting and fixing the cap 11 and device body 10 of the device for cryopreservation increases. Here, as shown in the above-described FIG. 12 and FIG. 16, the strip 7 having a distal end colored in black, for example, is suitable. When the length in the major axis direction of the device body 10 is larger than the length in the major axis direction of the device body holder 3, the device body 10 is held at a position where one end of the handle 9 of the device body 10 projects from the end of the auxiliary device for cryopreservation 16. This structure is preferred because the device for cryopreservation can be easily detached from the auxiliary device 16 and the device for cryopreservation can be efficiently immersed in liquid nitrogen even when the worker wears a protector such as gloves.

FIG. 17 is a schematic view showing an embodiment of the state where a cell or tissue is dropped and attached to a strip of a device for cryopreservation using the auxiliary device for cryopreservation of the present invention. As shown in FIG. 17, the cap 11 and the device body 10 are held by the auxiliary device for cryopreservation 16 without being fit to each other and a cell 13 and a preservation solution 14 are deposited on the strip 7 of the device body 10. The cell 13 and the preservation solution 14 on the strip 7 are preferably deposited under microscopic observation. The reference position indicator 6 is useful as it helps the worker visually recognize the position to which the cell 13 and the preservation solution 14 are to be dropped and attached.

The strip 7 on which the cell 13 and the preservation solution 14 are deposited is then covered with the cap 11 and the cap 11 is fitted and fixed to the device body 10.

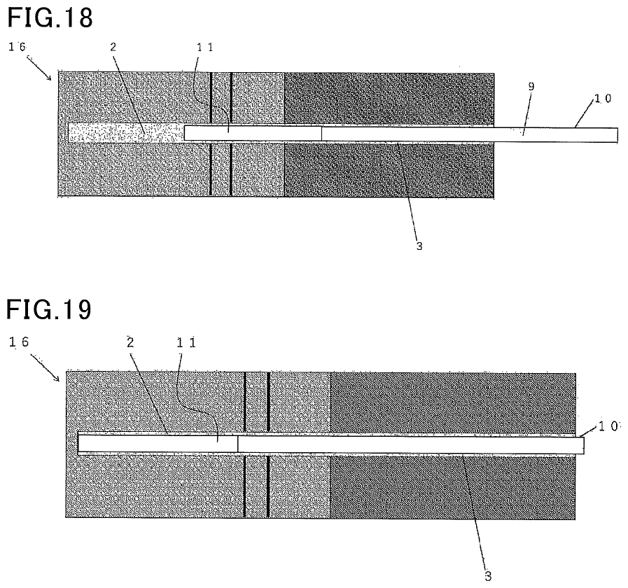

An embodiment of a fitting and fixing method is shown in which the cap 11 held by the cap holder 2 is slid along the wall faces of the groove in the direction of the device body holder 3. FIG. 18 is a schematic view showing an embodiment of the state where the device body and the cap are fitted and fixed using the auxiliary device for cryopreservation of the present invention according to the above method.

Alternatively, the strip 7 may be covered by sliding the device body 10 held by the device body holder 3 in the direction of the cap holder 2. FIG. 19 is a schematic view showing another embodiment of the state where the device body and the cap are fitted and fixed using the auxiliary device for cryopreservation of the present invention according to the above method.

After the device for cryopreservation, in which the device body and the cap are fitted and fixed as described above, is detached from the auxiliary device for cryopreservation, the cap side of the device for cryopreservation is immersed in liquid nitrogen and the cell or tissue deposited on the strip is cooled and frozen. At this time, the cell or tissue on the sealed strip is cooled without coming into contact with liquid nitrogen.

The time from deposition of the cell or tissue together with the preservation solution on the strip to immersion of the cell or tissue in liquid nitrogen through fitting and fixing of the device body and the cap is preferably about within one minute, more preferably within 30 seconds. Use of the auxiliary device of the present invention allows quick immersion of the cell or tissue in liquid nitrogen.

The cell or tissue frozen as described above is kept cool in the vitrified state in a low-temperature storage container in which the temperature is kept very low by liquid nitrogen or the like.

The cryopreservation method using the auxiliary device of the present invention is described above. Next, a preferred embodiment of a device for cryopreservation to be held by the auxiliary device of the present invention is described.

The device for cryopreservation includes the device body 10 and the cap 11 as described in FIG. 12 described above. The device body 10 of the device for cryopreservation includes the strip 7, the fitting structure 8, and the handle 9.

The strip 7 of the device body 10 preferably has an elongated rectangular shape. The elongated rectangular shape is preferred because it facilitates housing of the strip 7 in the cap 11.

Examples of the strip 7 of the device for cryopreservation in the present invention include various resin films, metal plates, glass plates, and rubber plates. The strip 7 may be made of one kind of material or two or more kinds of materials. In particular, resin films are suitable in terms of the handleability. Specific examples of the resin films include those made of, for example, a polyester resin such as polyethylene terephthalate or polyethylene naphthalate, acrylic resin, epoxy resin, silicon resin, polycarbonate resin, diacetate resin, triacetate resin, polyacrylate resin, polyvinyl chloride resin, polysulfone resin, polyethersulfone resin, polyimide resin, polyamide resin, polyolefin resin, or cyclic polyolefin resin. The strip 7 preferably has a total light transmittance of 80% or higher because such a strip allows a cell or tissue deposited thereon to be easily identified using a transmission microscope.

The strip 7 can also be a preservation solution absorber. Use of a preservation solution absorber as the strip 7 allows effective removal of excess preservation solution, increasing the freezing speed. Examples of the preservation solution absorber include a wire mesh, paper and a film material made of a synthetic resin and provided with through holes. The examples of the preservation solution absorber also include a porous structure formed using a material having a refractive index of 1.45 or lower. Use of the porous structure allows efficient removal of the preservation solution around the cell or tissue. Also, with a refractive index of 1.45 or lower, the porous structure allows easy deposition of a cell or tissue, freezing of the cell or tissue, and thawing after the freezing under observation with a transmission optical microscope with a favorable visibility without fail.

The refractive index of the material of the porous structure is measurable with the Abbe refractometer (Na light source, wavelength: 589 nm) in accordance with JIS K 0062:1992 and JIS K 7142:2014. Examples of the material having a refractive index of 1.45 or lower and defining the porous structure include plastic resin materials such as fluororesin, including polytetrafluoroethylene resin, polyvinylidene difluoride resin, and polychlorotrifluoroethylene resin, and silicon resin; metal oxide materials such as silicon dioxide; and inorganic materials such as sodium fluoride, magnesium fluoride, and calcium fluoride.

The preservation solution absorber, when it is a porous structure, preferably has a pore diameter of 5.5 μm or less, more preferably 1.0 μm or less, still more preferably 0.75 μm or less. This can increase the visibility of a cell or tissue under observation with an optical microscope. The preservation solution absorber preferably has a thickness of 10 to 500 μm, more preferably 25 to 150 μm. The pore diameter of the preservation solution absorber, in the case of a porous structure made of a plastic resin material, is the diameter of the largest pore measured by the bubble point test. In the case of a porous structure made of a metal oxide or an inorganic material, the pore diameter is the average pore diameter measured in observation of an image of the surface and cross section of the porous structure.

The preservation solution absorber preferably has a porosity of 30% or more, more preferably 70% or more. The porosity is defined by the following formula. The void volume V can be determined as the value per unit area (m²) by multiplying the cumulative pore volume (mL/g) by the dry solids content (g/m²) of the preservation solution absorber. The cumulative pore volume is the total volume of pores having a pore radius of 3 nm to 400 nm in the preservation solution absorber and is determined by measurement and data processing with a mercury porosimeter (name: Autopore II 9220, Micromeritics Instrument Corporation). The thickness T of the preservation solution absorber can be measured on a photograph of the cross section of the preservation solution absorber taken with an electron microscope.

P=(V/T)×100(%)

P: porosity (%)
V: void volume (mL/m²)
T: thickness (μm)

The cap 11 of the device for cryopreservation in the present invention can be formed using, for example, a material resistant to the cooling solvent, e.g., liquid nitrogen. Examples thereof include resins and metals. The cap may be made of one kind of material or two or more kinds of materials. In particular, a resin is preferred because it can be easily formed into a desired structure through a process such as injection molding. Specific examples of the resin include polyester resins such as polyethylene terephthalate and polyethylene naphthalate, acrylic resin, epoxy resin, silicon resin, polycarbonate resin, diacetate resin, triacetate resin, polyacrylate resin, polyvinyl chloride resin, polysulfone resin, polyethersulfone resin, polyimide resin, polyamide resin, polyolefin resin, and cyclic polyolefin resin. The cap preferably has a total light transmittance of 80% or higher for easy identification of the strip conditions inside the cap after the cap is fitted.

The device body 10 of the device for cryopreservation in the present invention includes the handle 9. The handle 9 has, for example, a circular, oval, or polygonal cross-sectional shape. From the viewpoint of grippability and operability, a rectangular shape or a square shape is preferred. The handle 9 is preferably a member formed using a material resistant to the cooling solvent such as liquid nitrogen. Suitable examples of the material include various metals such as aluminum, iron, copper, and stainless steel, ABS resin, acrylic resin, polypropylene resin, polyethylene resin, fluororesin, various engineering plastics, and glass.

The device body 10 of the device for cryopreservation in the present invention preferably includes the fitting structure 8. The fitting structure 8 is used to fit and fix the cap 10 and the device body 11 and can preferably have a tapered structure or a threaded structure.

The preservation solution for freezing of a cell or tissue in the present invention can usually be one used to freeze a cell such as an egg or embryo. Examples thereof include a preservation solution containing a physiological solution such as phosphate buffered saline and a cryoprotectant (e.g., glycerol, ethylene glycol) and a preservation solution containing a large amount (at least 10% by mass, more preferably 20% by mass of the total mass of the preservation solution) of a cryoprotectant such as glycerol, ethylene glycol, or dimethyl sulfoxide. The thawing solution for thawing can usually be one used to thaw a cell such as an egg or embryo. Examples thereof include a thawing solution containing the above-described physiological solution such as phosphate buffered saline and 1 M sucrose for osmoregulation.

Examples of the cell that can be cryopreserved in the present invention include reproductive cells such as eggs, embryos, and sperms from mammals (for example, human, bovine, swine, equine, leporine, rat, and mouse); and pluripotent stem cells such as induced pluripotent stem cells (iPS cells) and embryonic stem cells (ES cells). Also included are culture cells such as primary culture cells, subculture cells, and cell lines. In one or more embodiments, examples of the cell include adhesive cells such as fibroblasts, cancer-derived cells (e.g., pancreatic cancer cells and hepatoma cells), epithelial cells, vascular endothelial cells, lymphatic endothelial cells, neuronal cells, chondrocytes, tissue stem cells, and immune cells. Examples of the tissue that can be cryopreserved include tissues formed of homologous cells and tissues formed of heterologous cells, such as tissues of ovary, skin, corneal epithelium, periodontal ligament, and myocardium.

### EXAMPLES

The present invention is specifically described below in further details by referring to examples, but the present invention is not limited to the following examples.

### Example 1

The auxiliary device for cryopreservation 16 including the cap holder 2, the device body holder 3, and the observation section having an aperture structure 4 shown in FIG. 1 was produced using a polycarbonate resin having a total light transmittance of 85% by cutting. The substrate 1 had dimensions [length×width×height (thickness)] of 23 mm×80 mm×3 mm from the left end to 80 mm in the right direction (lateral direction) (the range including the cap holder 2 and the observation section having an aperture structure 4) and dimensions of 23 mm×90 mm×4 mm on the right thereof (the range in which the device body holder 3 was formed). The cap holder 2 had dimensions width×length×depth of 3.2 mm×35 mm×1 mm. The device body holder 3 had dimensions width×length×depth of 3.2 mm×90 mm×2 mm. The observation section having an aperture structure 4 had dimensions width×length of 5 mm×40 mm. The bottom face of the cap holder 2 and the bottom face of the device body holder 3 each had a height (thickness) of 2 mm from the bottom face of the substrate 1. One end (the left end in FIG. 1) of the groove in the cap holder 2 was blocked.

### Example 2

An auxiliary device for cryopreservation of Example 2 was produced as in Example 1 except that the substrate 1 had entirely the same height, the dimensions length×width×height were 23 mm×170 mm×3 mm, and the groove in the device body holder 3 had a depth of 1 mm. The bottom face of the cap holder 2 and the bottom face of the device body holder 3 each had a height (thickness) of 2 mm from the bottom face of the substrate 1.

### Example 3

The auxiliary device for cryopreservation 16 including the cap holder 2, the device body holder 3, and the observation section having an aperture structure 4 shown in FIG. 8 was produced using polycarbonate resin by cutting. The substrate 1 had dimensions length×width×height of 23 mm×80 mm×3 mm from the left end to 80 mm in the right direction (lateral direction) (the range including the cap holder 2 and the observation section having an aperture structure 4) and dimensions of 23 mm×90 mm×4 mm on the right thereof. The groove in the cap holder 2 had dimensions width×length×depth of 3.2 mm×35 mm×1 mm. The groove in the device body holder 3 had dimensions width×length×depth of 3.2 mm×90 mm×2 mm. The aperture of the observation section having an aperture structure 4 had dimensions width×length of 2.8 mm×40 mm. The observation section having an aperture structure 4 had a structure in which the aperture was surrounded by the bottom faces, and the width of the aperture was smaller than the widths of the cap holder 2 and the device body holder 3. In addition, the wall faces and the bottom faces of the cap holder 2, the observation section having an aperture structure 4, and the device body holder 3 were continuous without any step.

### Example 4

An auxiliary device for cryopreservation of Example 4 was produced as in Example 3 except that the right portion of the substrate 1 had dimensions length×width×height of 23 mm×45 mm×4 mm, and the groove in the device body holder 3 had a length of 45 mm.

### <Evaluation on Holding Condition of Device for Cryopreservation>

In order to evaluate the holding condition of the device for cryopreservation by each of the auxiliary devices for cryopreservation of Examples 1 to 4, the device for cryopreservation including the cap 11 and the device body 10 shown in FIG. 12 was produced. The cap 11 of the device for cryopreservation was produced using ABS resin. The external cross-sectional shape of the cap 11 was a square whose four sides each had a length of 3.1 mm. The cap 11 had a length in the major axis direction of 45 mm. The cap 11 was provided with a circular aperture at one end and the cavity 12 having a cylindrical shape continued from the aperture. The device body 10 of the device for cryopreservation had an external cross-sectional shape of a square whose four sides each had a length of 3.1 mm. The device body 10 included the handle 9 having a quadrilateral prism shape whose length in the major axis direction was 85 mm, the fitting structure 8 having a conical frustum shape whose length was 10 mm, and the strip 7 having a rectangular shape (width: 1.5 mm, length: 20 mm, thickness: 190 μm). The handle 9 and the fitting structure 8 were produced from ABS resin and bonded to the strip 7 produced from a polyethylene terephthalate resin film, whereby the device body 10 was produced. The cap 11 and device body 10 of the device for cryopreservation were respectively disposed on and held by the cap holder 2 and the device body holder 3 of each of the auxiliary devices for cryopreservation of Examples 1 to 4. The stability during this process was evaluated as the holding condition of the device for cryopreservation based on the following criteria. The results are shown in the column labeled “Holdability” in Table 1.

Good: The auxiliary device stably held the device for cryopreservation.

Fair: The auxiliary device was able to hold the device for cryopreservation, but the device body was sometimes in an instable state.

### <Working Efficiency in Covering Strip>

The auxiliary devices for cryopreservation of Examples 1 to 4 were evaluated on the working efficiency in covering the strip of the device body 10 of the device for cryopreservation with the cap 11. The cap 11 and device body 10 of the device for cryopreservation obtained as described above were respectively disposed on the cap holder 2 and device body holder 3 of the auxiliary device for cryopreservation of each of Examples 1 to 4, with the circular aperture side of the cap 11 and the strip 7 side of the device body 10 facing each other. Equilibrated 8-cell mouse embryos together with 0.1 μL of a preservation solution were dropped and attached to the strip 7 of the device body 10 under a transmission microscope. The preservation solution used had a composition in which 15 vol % dimethyl sulfoxide, 15 vol % ethylene glycol, and 17 mass % sucrose were contained in the Medium 199 available from Sigma-Aldrich. The cap 11 held by the cap holder 2 was then slid along the wall faces of the groove in the direction of the device body holder 3 to cover the strip 7. The cap 11 was then fitted and fixed to the device body 10. The working efficiency during this process was evaluated based on the following criteria. The results are shown in the column labeled “Working efficiency in covering” in Table 1.

Good: Fitting and fixing were smooth without the cap coming into contact with the cell or tissue deposited on the strip.

Fair: Fitting the cap by sliding was rather complicated but fixing was possible with no hindrance.

### <Working Efficiency in Immersion in Liquid Nitrogen>

The auxiliary devices for cryopreservation of Examples 1 to 4 were evaluated on the “working efficiency in covering the strip”, and then on the working efficiency in detaching the device for cryopreservation from the auxiliary device for cryopreservation and immersing the device in liquid nitrogen based on the following criteria. The worker wore a protector (gloves). The results are shown in the column labeled “Working efficiency in immersion in liquid nitrogen” in Table 1.

Good: The device for cryopreservation was smoothly detached and quickly immersed in liquid nitrogen.

Fair: Taking out the device for cryopreservation was rather complicated, but the series of processes in immersion in liquid nitrogen were possible with no hindrance.

TABLE 1

| | | Working | Working |
|---|---|---|---|
| | | efficiency | efficiency in |
| | | in | immersion in |
| | Holdability | covering | liquid nitrogen |
| Example 1 | Good | Fair | Fair |
| Example 2 | Fair | Fair | Fair |
| Example 3 | Good | Good | Fair |
| Example 4 | Good | Good | Good |

As is clear from the test results shown above, the present invention can provide an auxiliary device for cryopreservation that, in cryopreservation of a cell or tissue, can stably hold a device for cryopreservation, facilitates coverage of the cell or tissue deposited on a strip with a cap without allowing the cap to come into contact with the cell or tissue, and enables quick immersion of the device for cryopreservation in liquid nitrogen.

### INDUSTRIAL APPLICABILITY

The present invention can be applied to cryopreservation of cell or tissue such as cells or tissues for embryo transfer and artificial insemination of domestic animals (e.g., cattle) and other animals, and for human artificial insemination; iPS cells; ES cells; commonly used culture cells; cells or tissues, including embryos and eggs, harvested from living bodies, for the purpose of examination or implantation; and cells or tissues cultured in vitro.

What is claimed is:

1. An auxiliary device for cryopreservation, comprising:
a substrate;
a cap holder;
an observation section having an aperture structure; and
a device body holder,
the cap holder, the observation section having an aperture structure, and the device body holder being arranged on the substrate in a substantially straight line.

2. The auxiliary device for cryopreservation according to claim 1,
wherein the cap holder and the device body holder are each defined by a groove provided on the substrate.

3. The auxiliary device for cryopreservation according to claim 1,
wherein the cap holder and the device body holder are each defined by two lines of projections on the substrate.
